(19) United States
(12) Patent Application Publication
(10) Pub. No.: US 2004/0012213 A1
(43) Pub. Date: Jan. 22, 2004

(54) Bumper assembly

(76) Inventors: Paul Kenneth Dellock, Northville, MI (US); Philip Kotranza, New Baltimore, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/406,373

(22) Filed: Apr. 3, 2003

Related U.S. Application Data
(60) Provisional application No. 60/369,712, filed on Apr. 4, 2002.

(51) Int. Cl. B60R 19/48

(52) U.S. Cl. 293/117

(57) ABSTRACT

A tow hitch rear bumper assembly for a motor vehicle having a rear center bumper beam extending transversely for attachment to a frame of the motor vehicle, bumper brackets mounted to the frame and the center rear bumper beam wherein the bumper brackets are further attached to a pair of end members which generally are lighter in weight and gauge thickness than the rear center bumper beam. A tow hitch receiver is mounted about the center of the rear center bumper beam and the tow hitch is disposed within an aperture of the tow hitch receiver.

### CROSS-REFERENCE TO RELATED APPLICATION(S)

This patent application claims the benefit of U.S. Provisional application Ser. No. 60/369,712, filed Apr. 4, 2002.

### STATEMENT REGARDING FEDERALLY SPONSORED RESEARCH

The invention described herein was funded in part by a grant from the United States Government, Contract No. DAAE07-99-3-0010. The United States Government may have certain rights under the invention.

### BACKGROUND OF THE INVENTION

1. Field of the Invention

The present invention relates generally to rear bumpers for motor vehicles and, more specifically, to a tow hitch rear bumper assembly for a motor vehicle.

2. Description of the Related Art

It is known that a motor vehicle is equipped with a rear bumper assembly in order to protect its body in a low speed vehicle collision condition. It is also known that a separate tow hitch assembly may be equipped to a rear end of the motor vehicle in order to provide the motor vehicle with additional towing capacity. The rear bumper assembly typically includes a beam that extends transversely across the rear end of the motor vehicle. The tow hitch assembly typically but not necessarily includes a tow hitch receiver which is disposed under and welded to a transverse tubular cross member and the tubular cross member is mounted to a frame of the motor vehicle through a pair of mounting brackets.

Although the above separate rear bumper and tow hitch assemblies have worked well, it is desirable to integrate these two assemblies into a single assembly in order to share their rigidity for both functions. It is also desirable to have an assembly, which will be lightweight and more durable while still meeting the motor vehicle towing requirement. It is further desirable to provide an integrated assembly that will enhance the rear bumper protection function in a low speed vehicle collision condition. It is yet further desirable to provide an assembly in which the tow hitch extends through the rear bumper. It is still further desirable to provide a cover for the tow hitch and rear bumper. Therefore, there is a need in the art to provide an integrated tow hitch and rear bumper assembly for a motor vehicle.

### SUMMARY OF THE INVENTION

Accordingly, the present invention is a tow hitch rear bumper assembly for a motor vehicle. The tow hitch rear bumper assembly includes a rear bumper for attachment to a frame of the motor vehicle. The tow hitch rear bumper assembly also includes a tow hitch extending through and integral with the rear bumper.

One advantage of the present invention is that a tow hitch rear bumper assembly is provided for a motor vehicle. Another advantage of the present invention is that the tow hitch rear bumper assembly integrates a tow hitch and rear bumper for a motor vehicle. Yet another advantage of the present invention is that the tow hitch rear bumper assembly has a tow hitch which extends just under the rear bumper which raises the height or clearance of the tow hitch relative to a driving surface. Still another advantage of the present invention is that the tow hitch rear bumper assembly reduces possible damage to the motor vehicle in a low speed vehicle collision condition. A further advantage of the present invention is that the tow hitch rear bumper assembly is lightweight and meets motor vehicle towing requirements. Yet a further advantage of the present invention is that a cover assembly is provided for a motor vehicle to cover a tow hitch and rear bumper of the motor vehicle.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a first isometric view of a tow hitch rear bumper assembly, according to the present invention.

FIG. 2 is a second isometric view of a tow hitch rear bumper assembly, according to the present invention.

FIG. 3 is a plan view of the present invention.

FIG. 4 is a side view of the tow hitch rear bumper assembly.

FIG. 5 is a front view of the tow hitch rear bumper assembly.

### DESCRIPTION OF THE PREFERRED EMBODIMENT(S)

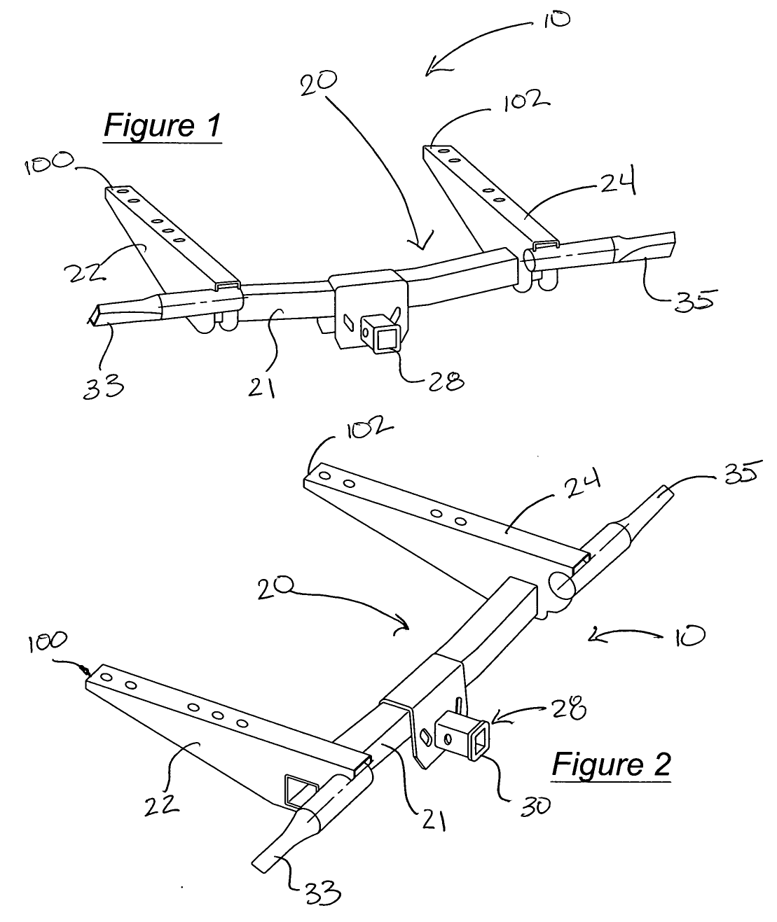

Referring to the figures and in particular FIGS. 1 and 2, one embodiment of a tow hitch rear bumper assembly 10, according to the present invention, is illustrated. The tow hitch rear bumper assembly 10 is located at a rear end of the motor vehicle and allows for towing of another vehicle such as a trailer (not shown) behind the rear end of the motor vehicle.

A motor vehicle includes a frame as is known in the art. The frame includes a pair of side rails extending longitudinally to the rear end of a motor vehicle and spaced transversely. The side rails are generally hollow with a rectangular cross-sectional shape. The side rails are made of a metal material such as steel. It should be appreciated that the side rails are conventional and known in the art. It should also be appreciated that, except for the tow hitch rear bumper assembly, the motor vehicle is conventional and known in the art.

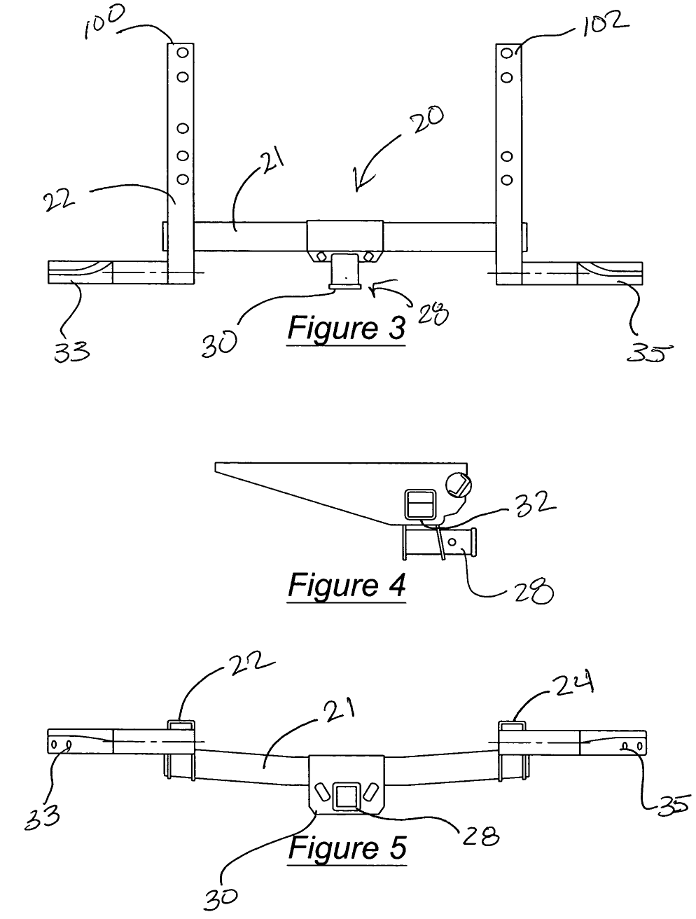

Referring to FIGS. 1 through 3, the tow hitch rear bumper assembly 10 includes a rear bumper, generally indicated at 20, at the rear end of the motor vehicle. The rear bumper 20 includes a rear center bumper beam 21 extending transversely. The rear center bumper beam 21 is hollow and has a generally rectangular cross-sectional shape. The rear center bumper beam 21 may also generally arcuate or curved transversely in shape, but may also be linear in shape. The rear center bumper beam 21 is made of a metal material such as steel.

The rear bumper 20 also includes at least one, preferably a pair of bumper brackets 22 and 24 to attach the rear center bumper beam 21 to the frame 14. The bumper brackets 22 and 24 may be hollow and may taper at the end where the bumper brackets mount to the frame at the ends of the bumper brackets 100, 102. The bumper brackets 22 and 24 are made of a metal material such as steel. The bumper brackets 22 and 24 are spaced transversely at the ends of the rear center bumper beam 21 and connected thereto by suitable means such as welding. Each bumper bracket 22, 24 is disposed over a corresponding side rail (not shown) of the frame. The bumper brackets 22 and 24 are connected to the side rails, respectively, by suitable means such as fasteners 26. It should be appreciated that, in this embodiment, the fasteners may be bolts and nuts extending through the sides of the bumper brackets 22 and 24 and side rails 16 and 18.

The tow hitch rear bumper assembly 10 also includes a tow hitch, generally indicated at 28, disposed below the rear bumper 20 as shown in FIGS. 1-5. The tow hitch 28 includes a hitch receiver 30 for receiving a hitch (not shown). The hitch receiver 30 is a plate mounted about the center bumper beam as shown in FIGS. 1-5. The tow hitch 28 is made of a metal material such as steel. As shown in FIG. 4, the tow hitch 28 extends longitudinally and is disposed below the bottom face 32 of the rear center bumper beam 21.

Under towing conditions, the rear center bumper beam 21 will act like a horizontal cross member to support the tow hitch 28.

Attached to the rear bumper brackets 22, 24 are end bumper members 33, 35. A first end bumper member 33 is attached to bumper bracket 22 and a second end bumper member 35 is attached to a bumper bracket 24. The first and second end bumper members 33, 35 are preferably, but not necessarily, made out of metal. The first and second end bumper members 33, 35 facilitate the attachment of the brackets to the frame by acting as an assembly aid. The first and second end bumper members 33, 35 are also generally have a smaller diameter than the center bumper beam 21 and have a thinner material gage thereby resulting in reduced weight and cost savings.

It is noted that when affixing the trailer hitch 28 to the center bumper beam 21, the center bumper beam 21 must have adequate strength to withstand the trailer hitch loads as the vehicle tows another object. However, in traditional bumpers where the center bumper beam extends beyond the bumper brackets 33, 35, the center bumper beam 21 gage thickness remains the same as the center bumper beam extends laterally beyond the bumper brackets. This results in higher weight and cost. As shown in FIGS. 1-5, end bumper members 33, 35 are implemented on the ends of the bumper brackets 22, 24 to provide support for the bumper fascia (not shown) and constitute the end portions of the bumper beam 20. In the embodiment shown in FIGS. 1-5, the end members 33, 35 may be formed as tubes. As shown in the Figures, the end members 33, 35 are stamped wall-to-wall at the lateral edges of the end members 33, 35 to facilitate proper assembly of the system onto the vehicle. Furthermore, the stamped end portions of the end members provide for improved packaging in the vehicle.

The trailer hitch 28 may be further angled in an upward direction which minimizes the distance between the hitch and the frame mounting brackets. This results in reducing the view of the hitch that is visible to the customer.

The present invention requires fewer components to achieve the objectives of having a bumper beam and a trailer hitch.

In operation of this bumper assembly 10, one function of the rear bumper beam 21 is to provide support for the hitch receiver 30. Another function of the rear center bumper beam 21 is to absorb low speed vehicle collision energy. In a low speed vehicle collision, the hitch receiver 30 and end members 33, 35 and the bumper brackets help the rear bumper beam 21 rebound back to its original shape through three-point contact to minimize repair cost. In a high speed vehicle collision by an object (not shown), the hitch receiver 30 and bumper brackets 22, 24 first move forward and push the vehicle on three points to distribute the load and prevent the premature bending of the side rails and the rear bumper beam 221. This will allow the rear bumper 20 to crush axially to maximize its energy absorption. Under towing conditions, the rear center bumper beam 21 will act like a horizontal cross member to support the tow hitch 28. It should be appreciated that the tow hitch 28 has a higher ground clearance to prevent damage thereto due to ramp angle when backing up.

The rear bumper assembly 10 may further include a wiring receiver (not shown) for receiving wiring, which may be connected to a trailer (not shown). The wiring receiver 268 is a hollow tube having a generally rectangular cross-sectional shape. The wiring receiver may be made of a metal material such as steel. The wiring receiver may extend longitudinally through an aperture (not shown) of the rear bumper beam 21 or through an aperture (not shown) in the hitch receiver. The wiring receiver may be connected to the rear center bumper beam 21 by a suitable means such as welding. It should be appreciated that the wiring receiver may have any suitable cross-sectional shape such as circular.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A tow hitch rear bumper assembly for a motor vehicle comprising:
a rear center bumper beam extending transversely for attachment to a frame of the motor vehicle, said rear bumper beam being hollow with a central closed cross-section;
a first bumper bracket mounted to the frame and supporting a first end of the rear center bumper beam;
a second bumper bracket mounted to the frame and supporting a second end of the rear center bumper beam;
a first end bumper member affixed to the first bumper bracket;
a second end bumper member affixed to the second bumper bracket;
a hitch receiver affixed to the rear center bumper beam; and
a tow hitch extending through said hitch receiver.

2. A tow hitch rear bumper assembly as set forth in claim 1 wherein each of said bumper brackets have an aperture extending therethrough to receive said center rear bumper beam.

3. A tow hitch rear bumper assembly as set forth in claim 1 wherein each of said bumper brackets have a portion extending longitudinally beyond said rear center bumper beam.

4. A rear bumper system as set forth in claim 1 wherein said tow hitch receiver is mounted about the longitudinal center of the center rear bumper beam and said tow hitch receiver includes an aperture.

5. A tow hitch rear bumper assembly as set forth in claim 16 wherein said tow hitch extends longitudinally through said at least one aperture.

6. A tow hitch rear bumper assembly as set forth in claim 5 wherein said tow hitch is welded to said rear bumper beam.

7. A tow hitch rear bumper assembly as set forth in claim 1 including a wiring receiver extending longitudinally through said at least one aperture and welded to said rear bumper beam.

8. A tow hitch rear bumper assembly for a motor vehicle comprising:
a rear center bumper beam extending transversely;
a first bumper bracket and a second bumper bracket connected to said rear center bumper beam for attachment to side rails of the motor vehicle, wherein the first and second bumper brackets have a portion extending longitudinally beyond said rear bumper beam;
a first end member affixed to the first bumper bracket; and
a second end member affixed to the second bumper bracket.

9. A tow hitch rear bumper assembly for a motor vehicle comprising:
a rear center bumper beam extending transversely for attachment to a frame of the motor vehicle, said rear bumper beam being hollow with a central closed cross-section;
a first bumper bracket mounted to the frame and supporting a first end of the rear center bumper beam;
a second bumper bracket mounted to the frame and supporting a second end of the rear center bumper beam;
a first end bumper member affixed to the first bumper bracket; and
a second end bumper member affixed to the second bumper bracket.
